(19) United States
(12) Patent Application Publication
(10) Pub. No.: US 2024/0118503 A1
(43) Pub. Date: Apr. 11, 2024

(54) OPTO-ELECTRIC COMPOSITE TRANSMISSION MODULE

(71) Applicant: NITTO DENKO CORPORATION, Osaka (JP)

(72) Inventors: Naoto KONEGAWA, Osaka (JP); Seiki TERAJI, Osaka (JP)

(73) Assignee: NITTO DENKO CORPORATION, Osaka (JP)

(21) Appl. No.: 17/768,415

(22) PCT Filed: Oct. 14, 2020
(86) PCT No.: PCT/JP2020/038768

§ 371 Date: Apr. 12, 2022

(30) Foreign Application Priority Data
Oct. 15, 2019 (JP) 2019-188844

(51) Int. Cl. G02B 6/42; G02B 6/43

(52) U.S. Cl. CPC G02B 6/4206; G02B 6/428; G02B 6/4293; G02B 6/43

(57) ABSTRACT

An opto-electric composite transmission module includes a motherboard and an opto-electric hybrid board. The opto-electric hybrid board includes an optical waveguide and an electric circuit board sequentially in the thickness direction. The optical waveguide includes a core layer, an under-cladding layer, and an over-cladding layer. The core layer includes a mirror. The electric circuit board includes a first terminal and a second terminal. The optical waveguide is disposed so that an opto-electric conversion element, which is electrically connected to the first terminal, can optically be connected to the mirror. The second terminal is electrically connected to the motherboard.

The present invention relates to an opto-electric composite transmission module.

### BACKGROUND ART

Supercomputers or data centers are known to be equipped with opto-electric composite transmission modules for high-capacity high-speed signal transmission in the equipment and/or between the connection cables and equipment.

For example, a parallel optical transmission device including an optical module board, a lens member mounted thereon, and a tape fiber optically connected to the lens member has been proposed.

The parallel optical transmission device described in Patent Document 1 includes a condenser lens disposed at the head of a tape fiber and a lens holder storing the condenser lens. Further, the tape fiber includes a plurality of optical fibers arranged in parallel in form of a tape.

### CITATION LIST

### Patent Document

Patent Document 1: Japanese Unexamined Patent Publication No. 2012-168563

### SUMMARY OF THE INVENTION

### Problem to be Solved by the Invention

Opto-electric composite transmission modules are required to be thinned. However, the parallel optical transmission device of Patent Document 1 cannot sufficiently be thinned because the lens member includes the lens holder.

Further, in the space of the rack in which the opto-electric composite transmission module is stored, the air flow is limited and heat accumulation easily occurs. Thus, the opto-electric composite transmission module is required to have excellent heat dissipating properties. The parallel optical transmission device of Patent Document 1, however, includes the lens member in which the condenser lens is stored in the lens holder. Thus, heat accumulation easily occurs in the lens holder. As a result, the above-mentioned requirement cannot be fulfilled.

On the other hand, it can be considered to provide another heat dissipating member in the lens member. However, the condenser lens is stored in the lens holder and the heat dissipating member cannot be brought into direct contact with the condenser lens. Thus, there is a disadvantage that the parallel optical transmission device of Patent Document 1 has poor heat dissipating properties.

The present invention provides an opto-electric composite transmission module that is thinned and has excellent heat dissipating properties.

### Means for Solving the Problem

The present invention [1] includes an opto-electric composite transmission module comprising: a motherboard; and an opto-electric hybrid board mounted on the motherboard, wherein the opto-electric hybrid board includes an optical waveguide and an electric circuit board sequentially in a thickness direction, the optical waveguide includes a core layer and a cladding layer covering the core layer, the core layer includes a mirror formed at an end of the core layer, the electric circuit board includes a first terminal and a second terminal, the first terminal and the second terminal can electrically be connected to each other, the optical waveguide is disposed so that an opto-electric conversion element electrically connected to the first terminal can optically be connected to the mirror, and the second terminal is electrically connected to the motherboard.

In the opto-electric composite transmission module, the opto-electric hybrid board includes the optical waveguide and the electric circuit board sequentially in the thickness direction. Light is transmitted by the optical waveguide, and the optical path of the light is converted by the mirror. This optically connects the mirror and the opto-electric conversion element. Thus, differently from the lens member of the parallel optical transmission device of Patent Document 1, a lens holder is not required. Consequently, the opto-electric composite transmission module can be thinned.

A heat dissipating member can be brought into direct contact with the optical waveguide. The opto-electric composite transmission module excellently dissipates the heat.

The present invention [2] includes the opto-electric composite transmission module described in [1], wherein the motherboard includes a motherboard terminal disposed on one surface in the thickness direction, and further includes an electrical connector being in contact with the second terminal and the motherboard terminal.

In the opto-electric composite transmission module, a second terminal can electrically connect the motherboard to the opto-electric hybrid board by being in contact with the electrical connector, which does not require a reflow process. Thus, the third terminal has high connection reliability.

The present invention [3] includes the opto-electric composite transmission module described in [1], wherein the motherboard, the optical waveguide, and the electric circuit board are sequentially disposed toward the one side in the thickness direction, the first terminal faces the one side in the thickness direction, the second terminal faces both sides in the thickness direction at a non-overlap portion that does not overlap the optical waveguide in the thickness direction in the electric circuit board, and the motherboard includes a motherboard terminal disposed on one surface in the thickness direction of the motherboard, wherein the opto-electric composite transmission module further includes a conductive member intervening between the second terminal and the motherboard and electrically connecting the second terminal and the motherboard.

In the opto-electric composite transmission module, the non-overlap portion does not overlap the optical waveguide and overlaps only the motherboard and the conductive member when being projected in the thickness direction. Thus, the overlap portion can be thinned (reduced in height).

The present invention [4] includes the opto-electric composite transmission module described in [1], wherein the motherboard, the electric circuit board, and the optical waveguide are sequentially disposed toward the one side in the thickness direction, the first terminal and the second terminal face the other side in the thickness direction, and the motherboard includes a motherboard terminal disposed on one surface in the thickness direction of the motherboard, wherein the opto-electric composite transmission module further includes a conductive member intervening between the second terminal and the motherboard and electrically connecting the second terminal and the motherboard.

The opto-electric composite transmission module allows the second terminal to face the motherboard, and thus has a simple structure.

The present invention [5] includes the opto-electric composite transmission module described in any one of [1] to [3], wherein the optical waveguide includes a plurality of the core layers.

Opto-electric composite transmission modules are required to transmit optical signals with high density. However, there is a limitation on the high-density optical signal transmission by the parallel optical transmission device of Patent Document 1 because the optical fibers of the tape fiber are separately covered with outer coats.

On the other hand, in the opto-electric composite transmission module of the present invention, the optical waveguide includes a plurality of core layers and the cladding layer collectively covers the core layers. Thus, high-density optical signal transmission using the optical waveguide can be achieved.

### Effects of the Invention

The opto-electric composite transmission module of the present invention is thinned and has excellent heat dissipating properties.

### BRIEF DESCRIPTION OF THE DRAWINGS

FIG. 1 is a cross-sectional view along a transmission direction of the first embodiment of the opto-electric composite transmission module of the present invention.

FIG. 2A and FIG. 2B are frontal cross-sectional views along a direction orthogonal to a longitudinal direction of the opto-electric composite transmission module shown in FIG. 1. FIG. 2A is a frontal cross-sectional view taken along line X-X of FIG. 1. FIG. 2B is a frontal cross-sectional view taken along line Y-Y of FIG. 1.

FIG. 3 is a cross-sectional view partially enlarging a variation of the opto-electric composite transmission module shown in FIG. 1.

FIG. 4 is a cross-sectional view along the transmission direction of the second embodiment of the opto-electric composite transmission module of the present invention (in the second embodiment, a motherboard, an electric circuit board, and an optical waveguide are sequentially disposed).

FIG. 5 is a cross-sectional view along the transmission direction of the third embodiment of the opto-electric composite transmission module of the present invention (the third embodiment includes an electrical connector electrically connecting the motherboard to the opto-electric hybrid board).

### DESCRIPTION OF THE EMBODIMENTS

### First Embodiment

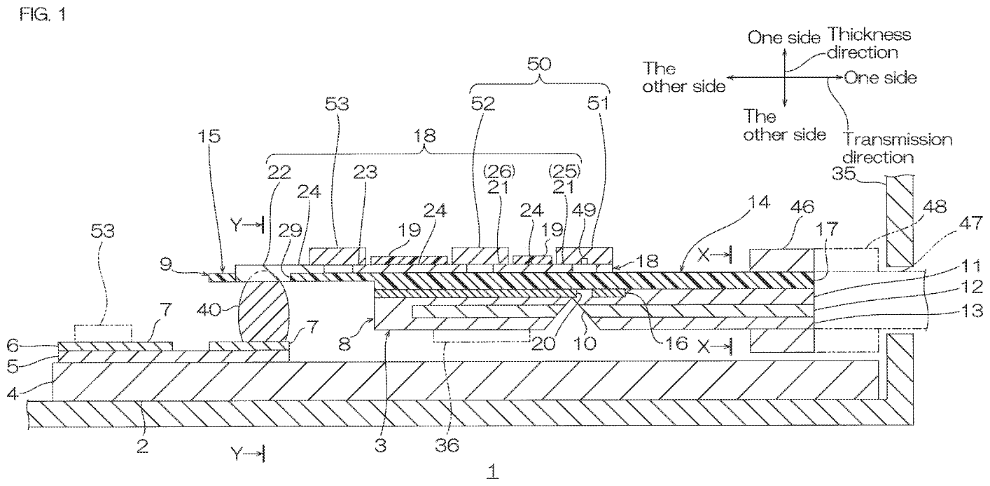

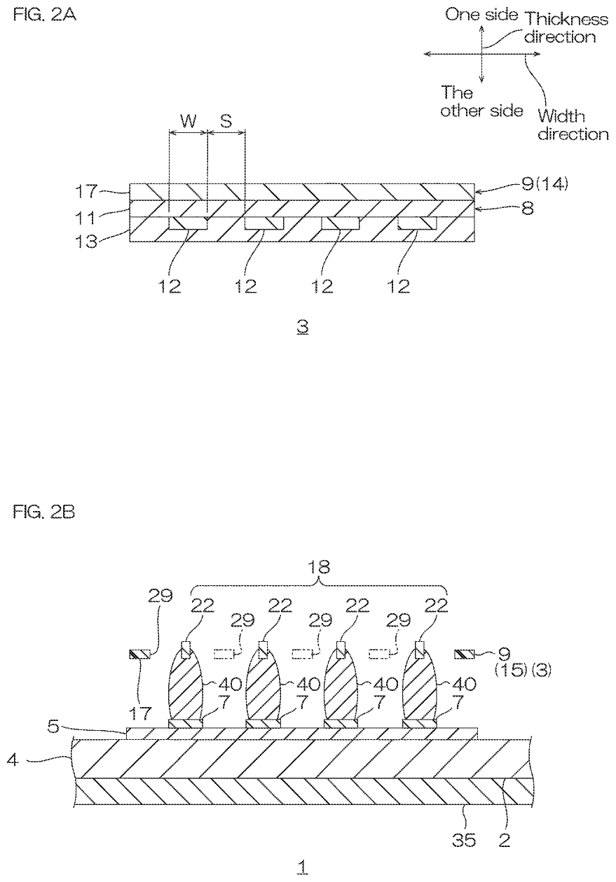

The first embodiment of the opto-electric composite transmission module of the present invention is described with reference to FIG. 1 to FIG. 2B.

An opto-electric composite transmission module 1 is disposed in, for example, a casing (specifically, a rack) 35 of equipment for high-capacity high-speed signal transmission, such as a supercomputer or a data center. The opto-electric composite transmission module 1 converts the light output from an optical fiber 47 shown by the phantom line into electricity, inputs the electricity to another processing device not illustrated, and converts the electricity output from the processing device not illustrated into light, and inputs the light to the optical fiber 47 shown by the phantom line. The opto-electric composite transmission module 1 has a predetermined thickness and a board shape extending along a transmission direction in which light and electricity are transmitted (hereinafter, may merely be referred to as the transmission direction). The opto-electric composite transmission module 1 includes a motherboard 2 and an opto-electric hybrid board 3 sequentially in a thickness direction.

The motherboard 2 has an approximate board shape extending in an orthogonal direction orthogonal to the thickness direction, and preferably has an approximately rectangular board shape. The motherboard 2 includes a motherboard supporting board 4, a motherboard insulating base layer 5, and a motherboard conductor layer 6.

The motherboard supporting board 4 has the same outer shape as that of the motherboard 2. Examples of the material of the motherboard supporting board 4 include hard materials such as glass-fiber reinforced epoxy resin.

The motherboard insulating base layer 5 is disposed on one surface in the thickness direction of the motherboard supporting board 4. Examples of the material of the motherboard insulating base layer 5 include insulating materials such as polyimide.

The motherboard conductor layer 6 is disposed on one surface in the thickness direction of the motherboard insulating base layer 5. The motherboard conductor layer 6 has a pattern including a motherboard terminal 7. Examples of the material of the motherboard conductor layer 6 include conductor materials such as copper.

The dimensions of the motherboard 2 in a plan view are not especially limited. The motherboard 2 has dimensions in which at least the opto-electric hybrid board 3 can be mounted, and specifically dimensions in which the opto-electric hybrid board 3 and another electronic board (such as an FPC) can be mounted.

The opto-electric hybrid board 3 is mounted on the motherboard 2. The opto-electric hybrid board 3 is disposed at one side in the thickness direction of the motherboard 2. Specifically, the opto-electric hybrid board 3 is mounted on one surface in the thickness direction of the motherboard 2. The opto-electric hybrid board 3 has a sheet shape extending along the transmission direction. The opto-electric hybrid board 3 includes an optical waveguide 8 and an electric circuit board 9 sequentially at one side in the thickness direction. The opto-electric hybrid board 3 includes the optical waveguide 8, and the electric circuit board 9 disposed on one surface in the thickness direction of the optical waveguide 8. Thus, the opto-electric composite transmission module 1 includes the motherboard 2, the optical waveguide 8, and the electric circuit board 9, which are disposed sequentially toward the one side in the thickness direction.

The optical waveguide 8 has an approximate sheet shape extending in the transmission direction. The optical waveguide 8 includes an under-cladding layer 11 as an exemplary cladding layer, a core layer 12, and an over-cladding layer 13 as an exemplary cladding layer.

The under-cladding layer 11 has the same shape as that of the optical waveguide 8 in a plan view. The under-cladding layer 11 has the other surface in the thickness direction, which is a flat surface. The under-cladding layer 11 has one surface in the thickness direction, which has a shape conforming to a metallic support layer 16 described below.

The core layer 12 is disposed at a width-direction intermediate portion of the other surface in the thickness direction of the under-cladding layer 11 (the width direction is a direction orthogonal to the thickness direction and the transmission direction) (the width direction is the direction of the depth of the paper sheet of the drawing of FIG. 1). For example, a plurality of the core layers 12 is separated by an interval therebetween in the width direction. The core layer 12 includes a mirror 10 formed at one end in the transmission direction of the core layer 12. The mirror 10 is a surface inclined at an angle of 45 degrees with respect to the other surface in the thickness direction of the under-cladding layer 11.

The over-cladding layer 13 is disposed on the other surface in the thickness direction of the under-cladding layer 11 to cover the core layers 12. Specifically, the over-cladding layer 13 is in contact with the other surface in the thickness direction of the core layers 12, a side surface width direction of the core layers 12, and the other surface in the thickness direction of the under-cladding layer 11 around the core layers 12. In the thickness direction, both side surfaces in the width direction of the over-cladding layer 13 are flush with both side surfaces in the width direction of the under-cladding layer 11. The over-cladding layer 13 and the under-cladding layer 11 cover the core layers 12 in the cross-sectional view.

The core layer 12 has a refractive index higher than those of the under-cladding layer 11 and the over-cladding layer 13. Examples of the material of the optical waveguide 8 include transparent materials such as epoxy resin. The optical waveguide 8 has a thickness of, for example, 20 μm or more and, for example, 200 μm or less, preferably 150 μm or less. Each of the core layers 12 has a width W of, for example, 100 μm or less, preferably 50 μm or less, more preferably 30 μm or less, and, for example, 1 μm or more. The adjacent core layers 12 are separated by a space S of, for example, 1000 μm or less, preferably 500 μm or less, more preferably 250 μm or less, and, for example, 10 μm or more in the width direction.

The electric circuit board 9 has an approximate board shape extending in the transmission direction. The electric circuit board 9, as illustrated in FIG. 1, has an overlap portion 14, which overlaps the optical waveguide 8, and a non-overlap portion 15, which does not overlap the optical waveguide 8, in the cross-sectional view taken along the transmission direction. The overlap portion 14 is one end and intermediate portion in transmission direction of the electric circuit board 9. The non-overlap portion 15 is the other end in the transmission direction of the electric circuit board 9. The other surface in the thickness direction of the non-overlap portion 15 is exposed from the electric circuit board 9 of the overlap portion 14.

The electric circuit board 9 includes the metallic support layer 16, an insulating base layer 17, a conductor layer 18, and an insulating cover layer 19 sequentially toward the one side in the thickness direction.

The metallic support layer 16 is disposed on the overlap portion 14. Specifically, the metallic support layer 16 is disposed at the other side in the thickness direction of the opto-electric conversion element 50 described below. The metallic support layer 16 has a metallic opening portion 20 penetrating in the thickness direction. A plurality of the metallic opening portions 20 is provided, corresponding to the first photoelectric conversion element 51 of the opto-electric conversion element 50 described below. The metallic opening portion 20 includes the mirror 10 when being projected in the thickness direction. Examples of the material of the metallic support layer 16 include metals such as a stainless-steel. The metallic support layer 16 has a thickness of, for example, 3 μm or more, and, for example, 100 μm or less, preferably 50 μm or less.

The insulating base layer 17 has a film shape extending in the transmission direction. The insulating base layer 17 has the same shape as that of the electric circuit board 9 in a plan view. In other words, the insulating base layer 17 is disposed on the whole of the overlap portion 14 and non-overlap portion 15.

The insulating base layer 17 has a part disposed on one surface in the thickness direction of the metallic support layer 16 on the overlap portion 14, and the other part. The insulating base layer 17 blocks one end in the thickness direction of the metallic opening portion 20. The insulating base layer 17 has a thick part, which faces the metallic support layer 16 in the thickness direction and is thicker than a part (thin part) surrounding the thick part. The insulating base layer 17 has light transmission properties. Examples of the material of the insulating base layer 17 include resins such as polyimide. The insulating base layer 17 has a thickness of, for example, 2 μm or more and 35 μm or less.

The conductor layer 18 is disposed across the overlap portion 14 and non-overlap portion 15. The conductor layer 18 includes a first terminal 21, a second terminal 22, a third terminal 23, and a wire 24.

The first terminal 21 is disposed on one surface in the thickness direction of the insulating base layer 17 on the overlap portion 14. The first terminal 21 faces the one side in the thickness direction. A plurality of the first terminals 21 is provided corresponding to a plurality of electrodes (not illustrated) of the opto-electric conversion element 50. The first terminals 21 include a first-element terminal 25 and a second-element terminal 26. A first photoelectric conversion element 51 (described below) is mounted on the first-element terminal 25. A second photoelectric conversion element 52 (described below) is mounted on the second-element terminal 26.

The second terminal 22 is disposed at the non-overlap portion 15. The second terminal 22 is, for example, a flying lead. Specifically, as illustrated in FIG. 2B, the second terminal 22 has a peripheral surface, which is in no contact with the insulating base layer 17 in a cross section orthogonal to the transmission direction. The peripheral surface of the second terminal 22 includes one surface and the other surface in the thickness direction and both side surfaces in the width direction. The insulating base layer 17 has a base opening portion 29, which penetrates the insulating base layer 17 in the thickness direction and includes the second terminal 22 in a plan view. A plurality of the base opening portions 29, as illustrated by the phantom lines of FIG. 2B, is provided corresponding to a plurality of the second terminals 22. Alternatively, as illustrated by the solid line of FIG. 2B, one large base opening portion 29 may be formed to expose the second terminals 22. The other surface in the thickness-direction of the second terminal 22 and both side surfaces in the width direction of the second terminal 22 are in contact with a conductive member 40 described below. The second terminals 22 are provided corresponding to the motherboard terminals 7.

The third terminal 23 is disposed at one side in the transmission direction of the second terminal 22 on the overlap portion 14. The third terminal 23 is disposed on one surface in the thickness direction of the insulating base layer 17.

The wire 24 connects the terminals, specifically, in a pattern that connects the first terminals 21 (the first-element terminal 25 to the second-element terminal 26), in a pattern that connects the second-element terminal 26 to the third terminal 23, and in a pattern that connects the third terminal 23 to the second terminal 22. The wire 24 is disposed on the one surface in the thickness direction of the insulating base layer 17.

Examples of the material of the conductor layer 18 include conductors such as copper. The conductor layer 18 has a thickness of 2 μm or more and 20 μm or less.

The insulating cover layer 19 is disposed on the overlap portion 14. The insulating cover layer 19 is disposed on the one surface in the thickness direction of the insulating base layer 17 to cover the wire 24. The properties, material, and thickness of the insulating cover layer 19 are the same as those of the insulating base layer 17.

The opto-electric composite transmission module 1 further includes the conductive member 40, an opto-electric conversion element 50, and an electron element 53.

The conductive member 40 is disposed between the motherboard terminal 7 (motherboard 2) and the second terminal 22 (electric circuit board 9). The conductive member 40 extends in the thickness direction. The conductive member 40 is in contact with the one surface in the thickness direction of the motherboard terminal 7, and with the other surface in the thickness direction of the second terminal 22 and with both side surfaces in the width direction of the second terminal 22. In this manner, the conductive member 40 electrically connects the motherboard terminal 7 to the second terminal 22. Examples of the material of the conductive member 40 include conductive materials such as a solder. The conductive member 40 is disposed between the motherboard terminal 7 and the second terminal 22, and is brought into tight contact with the motherboard 2 and the opto-electric hybrid board 3 by a reflow process to electrically connect them.

The opto-electric conversion element 50 is mounted on the electric circuit board 9. Specifically, the opto-electric conversion element 50 is mounted on one surface in the thickness direction of the electric circuit board 9. The opto-electric conversion element 50 includes the first photoelectric conversion element 51 and second photoelectric conversion element 52, which are electrically connected to the first-element terminal 25 and second-element terminal 26, respectively.

Examples of the first photoelectric conversion element 51 include light-emitting elements and light-receiving elements. A light-emitting element converts electricity into light. Specific examples of the light-emitting element include diodes such as a vertical-external-cavity surface-emitting-laser (VCSEL). A light-receiving element converts light into electricity. Specific examples of the light-receiving element include a photodiode (PD). The first photoelectric conversion element 51 include a window 49, which is a light emitting aperture of the light-emitting element and/or a light receiving aperture of the light-receiving element. The window 49 faces the other side in the thickness direction. The window 49 is included in the metallic opening portion 20 and overlaps (coincides with) the mirror 10 when being projected in the thickness direction. In this manner, the first photoelectric conversion element 51 is optically connected to the core layer 12.

The second photoelectric conversion element 52 may include a drive integrated circuit, an impedance converting amplifier circuit, and a re-timer integrated circuit. The drive integrated circuit drives the light-emitting element. The impedance converting amplifier circuit amplifies the electricity of the light-receiving element. The re-timer integrated circuit conditions the waveform of the electric signals.

The electron element 53 is mounted on, for example, the electric circuit board 9. Specifically, the electron element 53 is mounted on the one surface in the thickness direction of the electric circuit board 9. Specifically, the electron element 53 is mounted on the third terminal 23 and electrically connected thereto. Examples of the electron element 53 include processing elements such as a CMOS, a CPU, a GPC, and an ASIC switch.

The opto-electric composite transmission module 1 can include a PMT connector 46. The PMT connector 46 fixes a peripheral side surface of an end of the opto-electric hybrid board 3 at the one side in the transmission direction.

To produce the opto-electric composite transmission module 1, the motherboard 2 and the opto-electric hybrid board 3 are prepared. Sequentially, using the PMT connector (optical-waveguide MT connector) 46, one end in the transmission direction of the opto-electric hybrid board 3 is fixed. Next, the opto-electric conversion element 50 and the electron element 53 are mounted on the opto-electric hybrid board 3. Through the conductive member 40, the opto-electric hybrid board 3 is mounted on the motherboard 2. At the time, a reflow process is carried out to heat the conductive member 40. In this manner, the opto-electric composite transmission module 1 is produced.

Thereafter, the PMT connector 46 and the MT connector 48 which is illustrated by the phantom line and to which the optical fiber 47 illustrated by the phantom line is fixed are put together, thereby optically connecting the optical waveguide 8 of the opto-electric hybrid board 3 to the optical fiber 47.

The opto-electric composite transmission module 1 is used for not only the above-given examples (supercomputers and data center) but also, for example, the wires for commercially off-the-shell products or devices in other industries.

### Operations and Effects of First Embodiment

In the opto-electric composite transmission module 1, the opto-electric hybrid board 3 includes the optical waveguide 8 and the electric circuit board 9 sequentially in the thickness direction. Light is transmitted by the optical waveguide 8, and the optical path of the light is converted by the mirror 10, and thereby optically connecting the mirror to the first photoelectric conversion element 51. Thus, differently from the lens member of the parallel optical transmission device of Patent Document 1, a lens holder is not required, and thus the opto-electric composite transmission module 1 can be thinned.

A heat dissipating member not illustrated (specifically, for example, a heat dissipating sheet) can be brought into direct contact with (adhered to) the optical waveguide 8, and thus the opto-electric composite transmission module 1 has excellent heat dissipating properties.

In the opto-electric composite transmission module 1, the motherboard 2, the optical waveguide 8, and the electric circuit board 9 are sequentially disposed toward the one side in the thickness direction. The opto-electric conversion element 50 faces the one side in the thickness direction. The second terminal 22 faces both sides in the thickness direction on the non-overlap portion 15. Further, the second terminal 22 includes the conductive member 40 intervening between the second terminal 22 and the motherboard terminal 7 to electrically connect them. Thus, the non-overlap portion 15 does not overlap the optical waveguide 8 and overlaps only the motherboard 2 and the conductive member 40 when being projected in the thickness direction. Therefore, the opto-electric composite transmission module 1 including them can be thinned (reduced in height).

In the opto-electric composite transmission module 1, the optical waveguide 8 includes a plurality of the core layers 12, and the under-cladding layer 11 and the over-cladding layer 13 can collectively cover the core layers. Thus, high-density optical signal transmission using the optical waveguide 8 can be achieved. Further, the opto-electric composite transmission module 1 can be thinned

### <Variations>

In each of the following variations, the same members and steps as in the above-described first embodiment will be given the same numerical references and the detailed descriptions will be omitted. Further, the variations can have the same operations and effects as those of the first embodiment unless especially described otherwise. Furthermore, the first embodiment and the variations can appropriately be combined.

In the first embodiment, as illustrated by the solid line of FIG. 1, the electron element 53 is mounted on the third terminal 23 of the opto-electric hybrid board 3. For example, however, as illustrated by the phantom line of FIG. 1, the electron element 53 can be mounted on the motherboard terminal 7 of the motherboard 2.

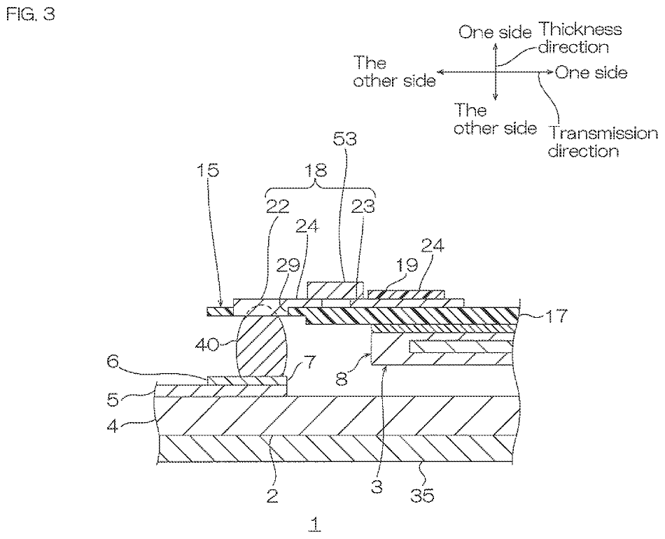

As illustrated in FIG. 3, the insulating base layer 17 has a thin part around the second terminal 22 and the other part can be a thick part.

Although not illustrated, for example, the second terminal 22 and the motherboard terminal 7 can electrically be connected via another board (such as a daughterboard).

### Second Embodiment

In the second embodiment, the same members and steps as in the above-described first embodiment and variations will be given the same numerical references and the detailed descriptions will be omitted. Further, the second embodiment can have the same operations and effects as those of the first embodiment and variations unless especially described otherwise. Furthermore, the first embodiment, the variations, and the second embodiment can appropriately be combined.

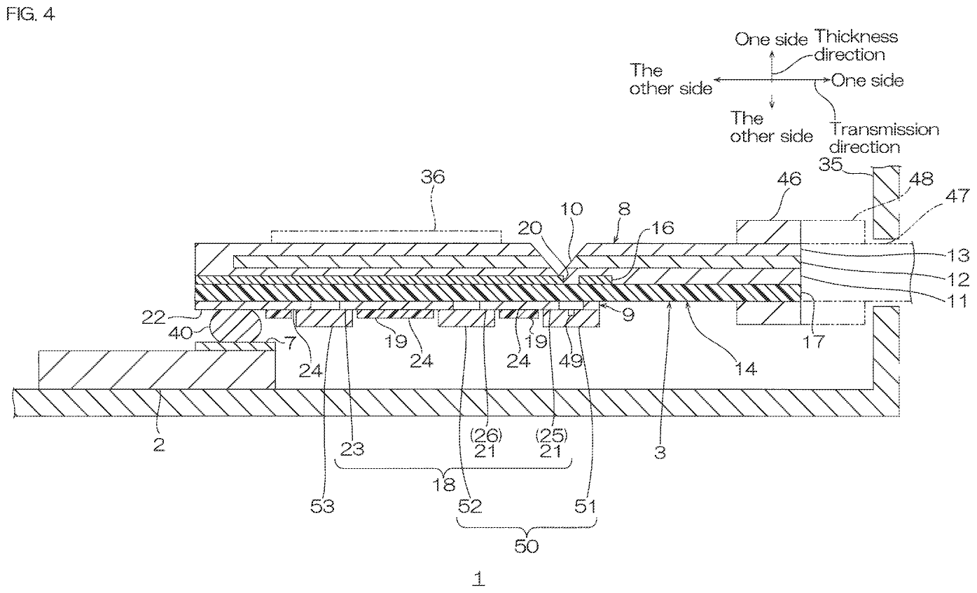

As illustrated in FIG. 4, in an opto-electric composite transmission module 1 of the second embodiment, a motherboard 2, an electric circuit board 9, and an optical waveguide 8 are sequentially disposed at one side in a thickness direction.

An opto-electric hybrid board 3 includes the electric circuit board 9 and the optical waveguide 8 sequentially toward the one side in the thickness direction. The opto-electric hybrid board 3 does not include the above-described non-overlap portion 15. The optical waveguide 8 is disposed on the whole of one surface in the thickness direction of the electric circuit board 9 in the cross-sectional view.

A second terminal 22 is not a flying lead and has one surface in the thickness direction, which is in contact with an insulating base layer 17. The second terminal 22 and a first terminal 21 face the other side in the thickness direction. Thus, the second terminal 22 faces the motherboard 2.

The conductive member 40 is in contact with the other surface in the thickness direction of the second terminal 22.

### Operations and Effects of Second Embodiment

The opto-electric composite transmission module 1 of the second embodiment includes the second terminal 22 that is not a flying lead. Thus, differently from the first embodiment, the formation of the base opening portion 29 on the insulating base layer 17 is not required. Hence, the opto-electric composite transmission module 1 of the second embodiment has a simpler structure than the opto-electric composite transmission module 1 of the first embodiment.

### Third Embodiment

In the third embodiment, the same members and steps as in the above-described first embodiment, variations, and second embodiment will be given the same numerical references and the detailed descriptions will be omitted. Further, the third embodiment can have the same operations and effects as those of the first embodiment, variations, and second embodiment unless especially described otherwise. Furthermore, the first embodiment, the variations, the second embodiment, and the third embodiment can appropriately be combined.

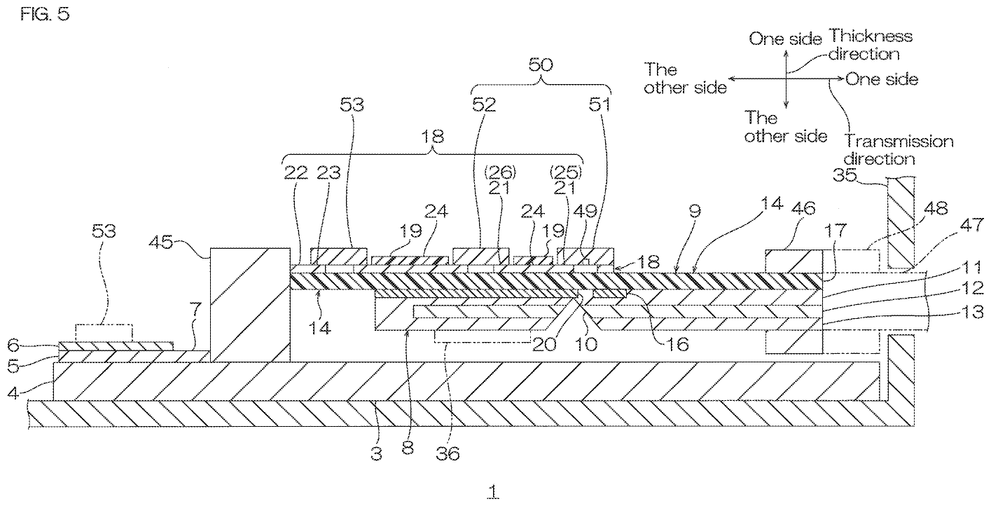

As illustrated in FIG. 5, the opto-electric composite transmission module 1 includes an opto-electric hybrid board 3, an optical waveguide 8, and an electric circuit board 9, which are disposed toward one side in a thickness direction in a similar manner to the first embodiment.

In a similar manner to the first embodiment, a second terminal 22 has the other surface in the thickness direction, which is in contact with an insulating base layer 17, and one surface in the thickness direction, which faces the one side. The second terminal 22 is located in proximity to the third terminal 23.

The opto-electric composite transmission module 1 includes an electrical connector 45 in place of the conductive member 40.

The electrical connector 45 is in contact with a motherboard terminal 7 and the second terminal 22. This electrically connects the motherboard 2 to the opto-electric hybrid board 3. Examples of the electrical connector 45 include an FPC connector, a ZIF connector, and a substrate connector. For example, the electrical connector 45 has an insertion opening (not illustrated) so that the other end in the transmission direction of the opto-electric hybrid board 3 is inserted thereto. This brings an electrode inside the electrical connector 45 into contact with the second terminal 22, and electrically connects the electrical connector 45 and the second terminal 22.

### Operations and Effects of Third Embodiment

At the reflow process of the conductive member 40 in the first embodiment, however, the opto-electric hybrid board 3 may be deformed due to the difference in thermal expansion coefficient between the optical waveguide 8 and the electric circuit board 9, and the deformation moves (slides) the second terminal 22. This may decrease the connection reliability of the second terminal 22 to the motherboard terminal 7.

On the other hand, in the third embodiment, the third terminal 23 is in contact with the electrical connector 45, which does not require a reflow process, instead of the conductive member 40, which requires a reflow process, to electrically connect the motherboard 2 and the opto-electric hybrid board 3. Thus, the third terminal 23 has high connection reliability.

While the illustrative embodiments of the present invention are provided in the above description, such is for illustrative purpose only and it is not to be construed as limiting in any manner Modification and variation of the present invention that will be obvious to those skilled in the art is to be covered by the following claims.

### INDUSTRIAL APPLICABILITY

The opto-electric composite transmission module is used for high-capacity high-speed signal transmission.
1 opto-electric composite transmission module
2 motherboard
3 opto-electric hybrid board
7 motherboard terminal
8 optical waveguide
9 electric circuit board
10 mirror
11 under-cladding layer
12 core layer
13 over-cladding layer
15 non-overlap portion
21 first terminal
22 second terminal
45 electrical connector
40 conductive member
50 opto-electric conversion element

1. An opto-electric composite transmission module comprising:
a motherboard; and
an opto-electric hybrid board mounted on the motherboard, wherein
the opto-electric hybrid board includes an optical waveguide and an electric circuit board sequentially in a thickness direction,
the optical waveguide includes a core layer and a cladding layer covering the core layer,
the core layer includes a mirror formed at an end of the core layer,
the electric circuit board includes a first terminal and a second terminal, the first terminal and the second terminal can electrically be connected to each other,
the optical waveguide is disposed so that an opto-electric conversion element electrically connected to the first terminal can optically be connected to the mirror, and
the second terminal is electrically connected to the motherboard.

2. The opto-electric composite transmission module according to claim 1, wherein the motherboard includes a motherboard terminal disposed on one surface in the thickness direction, and further includes an electrical connector being in contact with the second terminal and the motherboard terminal.

3. The opto-electric composite transmission module according to claim 1, wherein the motherboard, the optical waveguide, and the electric circuit board are sequentially disposed toward the one side in the thickness direction,
the first terminal faces the one side in the thickness direction,
the second terminal faces both sides in the thickness direction at a non-overlap portion that does not overlap the optical waveguide in the thickness direction in the electric circuit board, and
the motherboard includes a motherboard terminal disposed on one surface in the thickness direction of the motherboard, wherein the opto-electric composite transmission module further includes a conductive member intervening between the second terminal and the motherboard and electrically connecting the second terminal and the motherboard.

4. The opto-electric composite transmission module according to claim 1, wherein the motherboard, the electric circuit board, and the optical waveguide are sequentially disposed toward the one side in the thickness direction,
the first terminal and the second terminal face the other side in the thickness direction, and
the motherboard includes a motherboard terminal disposed on one surface in the thickness direction of the motherboard, wherein the opto-electric composite transmission module further includes a conductive member intervening between the second terminal and the motherboard and electrically connecting the second terminal and the motherboard.

5. The opto-electric composite transmission module according to claim 1, wherein the optical waveguide includes a plurality of the core layers.
